(19) United States
(12) Patent Application Publication
(10) Pub. No.: US 2016/0180303 A1
(43) Pub. Date: Jun. 23, 2016

(54) SYSTEM, METHOD, AND COMPUTER PROGRAM PRODUCT FOR PROCESSING PAYMENTS

(71) Applicant: U.S. Payments, LLC, Tulsa, OK (US)

(72) Inventors: Tim Neece, Sperry, OK (US); Jim Bennett, Tulsa, OK (US); Brandon Shane Skidgel, Jenks, OK (US)

(21) Appl. No.: 14/863,280

(22) Filed: Sep. 23, 2015

Related U.S. Application Data
(63) Continuation of application No. 11/846,000, filed on Aug. 28, 2007, now abandoned.
(60) Provisional application No. 60/823,744, filed on Aug. 28, 2006.

(51) Int. Cl. G06Q 20/10; G06Q 20/40

(52) U.S. Cl. CPC G06Q 20/102; G06Q 20/401

(57) ABSTRACT

Embodiments of the present invention are generally directed to systems, methods, and computer program products for verifying payment data related to payments sent from a payor to a biller and/or accelerating posting of such payments. More particularly, a system is provided for receiving payment data related to a payment sent from a payor to a biller and for verifying the accuracy of the payment data before allowing the biller to accept the payment. The system is configured to verify the accuracy of the payment data by comparing at least a portion of the payment data to the biller's substantially real-time account records. The system is then configured to allow the biller to accept payments that include accurate data and to identify those payments that do not include accurate data. The system may further be configured to provide the source of the payment data with an indication that the payment data is inaccurate.

### CROSS-REFERENCE TO RELATED APPLICATIONS

This application is a Continuation of U.S. patent application Ser. No. 11/846,000, entitled, SYSTEM, METHOD, AND COMPUTER PROGRAM PRODUCT FOR PROCESSING PAYMENTS, filed on Aug. 28, 2007, the entire contents of which is herein incorporated by reference, and from which priority is claimed under 35 U.S.C. §120. As in the parent application Ser. No. 11/846,000, this patent application also claims benefit of U.S. Provisional Application No. 60/823,744, filed on Aug. 28, 2006, the entire contents of which is herein incorporated by reference, and from which priority is claimed under 35 U.S.C. §119.

### FIELD OF THE INVENTION

Embodiments of the present invention relate generally to receiving and processing payments sent from a payor to a biller, and more particularly, relate to systems, methods, and computer program products for verifying payment data related to such payments and/or accelerating posting of such payments.

### BACKGROUND

Receiving and processing payments for services rendered is critical to the financial success of any business. This is especially true for businesses that provide ongoing or recurring services and bill their customers on a periodic basis (such as monthly) for those services. Examples of these types of businesses include various utility service providers, e.g., alarm service providers, electric service providers, telephone service providers, water service providers, Internet service providers, cable television service providers, natural gas service providers, etc.

While receiving and processing payments for goods or services is a necessary and important activity for these businesses, it is also a costly and time-consuming activity. Referring to FIGS. 1 and 2, a simplified view of a conventional payment receiving and processing system is illustrated in which some of the parties that may be involved in a conventional payment receiving and processing system and the general flow of payment information from one party to the next is identified. The parties often involved in a conventional payment receiving and processing system include the payor 110, originator 120, concentrator 130, and biller 150.

The biller 150 may be any party that originates bills or statements for goods or services rendered to a consumer. For example, the biller 150 may be a business (such as the utility providers mentioned above), the government, or an intermediary billing and collection service. The payor 110 is typically the consumer of the biller's goods or services, although the payor may be another party submitting payment for the consumer.

When a consumer receives a bill from a biller 150, the consumer or other payor 110 often submits a payment 115 to the biller by mailing a form of payment along with a remittance stub that the payor received from the biller. The form of payment may be a personal check, a bank check, a money order, or possibly a credit card authorization. Many payors, however, do not have checking accounts or credit cards or otherwise simply prefer to pay in cash. In particular, low-income or elderly consumers may choose to pay with cash. In some systems, these payors may be able to tender payment to a third-party originator 120 that has a business arrangement with the biller 150 and, thus, is willing to accept a payor's payment and forward the payment on to the biller. For example, many grocery stores accept payments on behalf of utility companies.

Although mailing in payments in the form of a check may still be the most popular form of remittance, an increasing number of payors 110 are choosing to submit payments electronically. Such payors may allow the biller 150 or the biller's agent to withdraw payment for a bill directly from the payor's bank account. Alternatively, payors may submit a payment by transmitting an electronic check or credit card authorization over a computer, a telephone, or some other electronic or wireless device or kiosk. For example, U.S. patent application Ser. No. 11/321,654 filed on Dec. 29, 2005, and claiming priority from U.S. Provisional Application No. 60/640,923 filed on Dec. 31, 2004, discloses a system, method, and computer program product for receiving and processing payments, and is assigned to the assignee of the present application.

Today, many payors 110 are purchasing software or are subscribing to online systems that allow the payor to electronically transmit payments to a biller 150. For example, a payor may subscribe to a third-party bill-pay system operated by a party other than the biller. These bill-pay systems attempt to consolidate all of a payor's bills from various billers in one place so that the payor can view and/or pay all of the payor's bills at one time by going to a single place on the Internet and using a single password. These bill-pay systems provide another example of an originator 120 that is willing to accept payment data from the payor and forward it on to the biller. Therefore, as used herein an “originator” 120 may be any entity that takes payment from a payor 110 with the intent of forwarding the payment to the biller.

Although there may be many ways that a payor 110 may desire to submit a payment to a biller 150, a small biller that receives only a payment or two per day may not have adequate systems in place in order to easily receive payments from all of the possible payment presentment systems. Therefore, a small biller will often contract with a third-party that can accept many different types of payments for the biller, process these payments, and forward the payments or certain select payment data to the biller, including the name of the payor, the account number, amount paid, etc. A large biller, on the other hand, may receive tens of thousands of payments per hour. The large biller will also often contract with a third-party in order to reduce overhead and the per transaction cost of receiving and processing payments. By doing so, the large biller can focus its efforts on its own business without having to manage a major payment receiving and processing operation and without having to keep up with new payment presentment methods that are continually being developed and/or desired by their consumers. Therefore, instead of having payors submit their payments directly to the biller, many billers in conventional payment receiving and processing systems require payors 110 (or their originators 120) to submit their payments to a central receiving location, sometimes referred to as a “lockbox operator” or a “concentrator” 130. The concentrator 130 then transmits the payments or select payment data to the appropriate biller 150. One example of a concentrator may be MasterCard's RPPS system.

Therefore, as illustrated in FIG. 1, a conventional payment receiving and processing system may involve a payor 110 submitting a payment 115 to an originator 120. The originator 120 may then submit payment data 125 relating to the payor's payment 115 to the biller's concentrator 130. The concentrator 130 then sorts through the payment data 125 that it receives (either directly from payors 110 or their originators 120) in order to determine which payments go to the biller 150. The concentrator 130 sends a batch file to the biller 150 containing payment data 135 from one or more payors 110. A batch file is typically sent each day that contains the payment data for the preceding day. As will be described below, payment data 125 and payment data 135 may comprise the same payment information that was originally submitted by the payor or may each comprise only a portion of the payment information submitted by the payor.

For simplicity, not all of the parties that may be present in a conventional payment receiving and processing system have been illustrated in FIGS. 1 and 2 or are discussed herein in detail. For example, naturally the payor's bank is often involved in a typical payment processing system, as is the biller's bank. As such, where FIG. 1 illustrates that the concentrator 130 sends payment data to the biller 150, the payment may go from the concentrator directly to the biller or, instead, may go to the biller 150 through the biller's bank (not shown). Other parties or systems that are not shown in the figures but may be involved in the system include a clearing house system or other system for transferring money between the various banks and financial institutions involved in the system.

Referring to FIG. 2, a conventional payment receiving and processing system and method is illustrated, that may be preformed by the parties illustrated in FIG. 1. As represented by block 210, the consumer typically receives an invoice from the biller. The invoice often includes remittance information that the biller uses to associate the bill, and any payment made toward the bill, with the consumer's account. Such remittance information usually includes, at a minimum, a consumer account number representing the consumer's account with the biller, and a minimum amount due on the consumer's account. The remittance information may also include other information such as a payment due date, an account balance, the consumer's name and address, the biller's name and address, and/or any other data that may be useful to link the payment to the biller and/or to the consumer's account with the biller.

In response to the biller's invoice, the payor 110, which may be the consumer or some other party paying on behalf of the consumer, submits a payment on the bill, as represented by block 220. As described above, the payor may submit payment in a variety of ways. For example, the payor may mail a check or electronically transmit a credit card authorization. As also described above, the payor may transmit the payment (including a form of payment along with at least some minimum remittance information) directly to the biller's concentrator 130 or to the biller's concentrator 130 via an originator 120. The payor and/or the originator may transmit payments or payment data either by mail or by wired and/or wireless communication.

If the payor 110 transmits a payment through an originator 120, the originator may forward payment data on to the concentrator 130 in a variety of ways. Some originators may simply forward the payor's payment directly to the concentrator exactly as it was presented to the originator. For example, a payor may present to the originator all of the remittance information on the invoice along with some form of payment. Some originators may forward all of this remittance information to the concentrator. Other originators, however, may choose to send only the information that they consider to be necessary for the biller to have in order to associate payment with a particular consumer's account. For example, the originator may choose to send the concentrator only the consumer's account number with the biller. Likewise, with regard to the payor's actual form of payment, some originators may forward the payor's form of payment to the concentrator exactly as the originator receives it, while other originators may keep the payor's form of payment and submit to the concentrator its own form of payment in lieu of one or more payors' payments.

For example, a large originator may service many different payors that pay bills to the same biller. In such a situation, periodically (e.g., once per day) the originator may simply submit one large check to the concentrator, the check representing the sum of all of the individual payors' remittances to a particular biller that were received by the originator during that period. This check may be accompanied by a list that includes payor account numbers and amounts tendered by each payor whose remittances are part of the single check. This presentment method is often referred to as the “check-and-list” presentment method.

As a result of the variety of presentment systems that a payor may choose to use, the concentrator may receive many different forms of payment data for a particular biller, as represented by block 230. The concentrator will likely receive payments directly from many payors and will also likely receive payment data and/or check-and-list payment data from many originators. Furthermore, since the concentrators usually work for many billers, the concentrators not only receive payment data from many sources, but the concentrators also receive payment data directed to many different billers. As such, the concentrators must sort through all of the payment data that they receive and attempt to locate which payments go to which biller.

In this regard, as represented by block 232, the concentrator must determine whether a biller can be identified from the payment data that the concentrator receives. The concentrator may decide this by searching for a known biller identifier, such as a known biller name, a known biller bank account number, or a predetermined biller identification number. In many conventional systems, this is all that the concentrator looks for. Once the concentrator determines that it has received an identifier for a known biller, the concentrator can forward the associated payment data to the appropriate biller. If the concentrator cannot identify a known biller from the received payment data, the concentrator may then return the payment to the payor or originator from which it came and/or notify the payor or originator that there was an error in the payment data, as represented by block 234.

In some systems, the concentrator takes an additional step, represented by block 236, of determining whether the consumer account numbers that it receives are in the proper format for the identified biller. So that the concentrator may make this determination, the biller may provide the concentrator with one or more standard formats that all of the biller's consumer account numbers should be in. For example, all of the consumer account numbers for a certain biller may begin with a particular collection of characters or all of the account numbers may consist of a certain quantity of numbers or letters. In some systems, the biller provides the concentrator with an algorithm that the concentrator can use to determine if a consumer account number belongs to or is a valid consumer account number for that biller. If the concentrator determines that a consumer account number that it receives with some payment data does not match the account number format of the biller identified by that payment data, the concentrator may then return the payment to the payor or originator from which it came and/or notify the payor or originator that there was an error in the payment data, as represented by block 234.

If the concentrator determines that the received payment data does identify a known biller and has the proper consumer account number format, the concentrator can present payment data to the biller (and/or the biller's bank, depending on the system). In a typical conventional system, the concentrator combines all of the payments that it receives for a particular biller and, once per day, submits to the biller a batch file containing payment data for the preceding day. Payment data sent from the concentrator to the biller may be in various formats depending on such things as the format that the biller asks the concentrator to send payment data in, and/or the types of payment data that the concentrator receives from payors and originators. As described above with respect to the originators, some concentrators may submit payment data to a biller using the check-and-list presentment method.

Once the biller receives the payment data from the concentrator, the biller attempts to post the received payments to the received consumer account numbers. With the payment data having possibly crossed several parties' hands throughout the payment receiving and processing system, errors often arise in the payment data received by the biller. One relatively common type of error is an error in the consumer's account number for the consumer's account with the biller. For example, the payor may have typed in the wrong consumer account number when entering the remittance information into an online bill-pay system. In another example, the bar code on the consumer's remittance stub that is used by a party, such as an originator, to automatically determine the consumer account number may be torn or otherwise disfigured leading to an error in the payor's account number that is ultimately presented to the biller. Sometimes, the consumer's account may have changed, and the consumer's account number received by the biller is simply out of date and does not match any current account number in the biller's database. These types of errors in the consumer account number, as well as errors in other payment data presented to the biller, can prove to be very costly for the biller.

Usually, the biller does not recognize an error until the biller attempts to post the received payment to the consumer's account, as represented by block 250 in FIG. 2. For a large biller, the process of receiving payment data and posting payments to the consumer accounts is often an automated process. Therefore, when the biller's system attempts to post a payment to a consumer account number that is not in the biller's database, the payment becomes an exception item. The exception items must then be looked into separately by the biller, often involving a manual process, in order for the biller to attempt to determine why the payment could not be posted.

Once the biller identifies the problem, the biller must then have a system in place to attempt to resolve the payment problem. In the case of an invalid consumer account number, the biller has often already accepted the money from the payor by this point but the biller does not know to which consumer account number to apply the credit. Therefore, the biller must research from whom the payment came. Since the error may be a result of a mistake by the consumer, the payor, the originator, the concentrator, or the biller, it may be difficult to track down which consumer account number to apply the payment to. It may be especially difficult and costly for the biller to track down the correct remittance information since the biller is the party in the payment receiving and processing system most removed from the payor/consumer. Furthermore, the remittance information that the biller sends to the consumer may be paired down by each of the parties in the receiving and processing system. For example, the biller may have to try to determine what to do with the payment given only an invalid consumer account number, or some other very limited remittance information. As a result, if the biller chooses to attempt to resolve the problem, the biller must work backwards through the parties in the payment system in order to attempt to gain information about the consumer account that the payment was intended for.

Ultimately, the biller may not be able to resolve the problem caused by an error in the payment data. Some billers may simply decide that it is too costly to even attempt to do so. In either case, the biller is left with a payor's money and no consumer account to post the payment to. Of course, the biller will usually eventually determine the consumer account to post the payment to if and when a consumer questions why its payment was withdrawn from its bank account but not posted to its consumer account with the biller. A similar result may occur if there is an error in the received consumer account number, but the consumer account number with the error is a valid consumer account number. This may result in a payment being applied to the wrong consumer account. In such a case, the biller might not even discover that an error has occurred until the biller receives a call from one of the two consumers.

Although, as described above, in some conventional systems the biller may provide the concentrator with an algorithm that allows the concentrator to check that the submitted consumer account number is in a format consistent with the biller's consumer account number format, incorrect account numbers still make it through the system that are in the correct format but have mistyped or incorrect characters.

In one attempt to solve the problem, a biller supplies a table of valid consumer account numbers to a third party, such as the biller's bank. When the biller's bank receives payment data from the concentrator, the biller's bank may run a further check to see if the consumer account numbers that it receives match a consumer account number in the table supplied by the biller. This solution, however, forces the biller to go through the steps of generating such a table for the third party and supplying it to the third party. Such a process is cumbersome and may involve substantial additional costs to the biller and the third party to generate and supply such a table. Furthermore, new consumer accounts are continually opened, old accounts are closed, and many accounts are changed. As a result, such a table may become out of date as soon as it is generated.

Another significant problem with such a solution is the fact that the biller must disclose confidential consumer account information to one or more third parties. By generating tables of consumer account information and supplying these tables to one or more third parties, the biller potentially looses control of this confidential information. The consumer's are concerned with the biller sharing such information for fear of their privacy being compromised and/or their identity being stolen. Likewise, a biller's customer list is often valuable intellectual property that the biller must or should protect.

Finally, another major problem with the conventional system is that the system is limited to sending batch files of payments to the biller once per day. This can create problems for the biller, as well. For example, many billers (e.g., service providers) typically discontinue service to a consumer when the consumer has not paid a bill by a particular due date. With the delays in the conventional payment receiving and processing system, a consumer may have made the payment and yet still have their service discontinued since the credit usually does not post to the consumer's account with the biller until the day after the concentrator processes it. This is due primarily to the fact that the legacy systems that make up the conventional payment processing system are limited to sending batch files once per day. This can impose substantial costs on the biller if the biller takes action to discontinue service to the consumer and then must quickly reinstall or reconnect service once the biller realizes that payment was actually received by the due date. Furthermore, the biller may have problems with its consumers, the government, and other groups if the biller shuts off service to a consumer when the consumer's payment was in the hands of the concentrator by the payment due date.

Therefore, it would be desirable if a system, method, and computer program product could be provided that could efficiently verify payment data, such as a consumer's account number, by checking the data in real time against the biller's database. Preferably, payments would be verified quickly and often so that any errors can be found before the biller accepts the payment and the payment can be instantly sent back to the preceding party in the payment receiving and processing chain. Preferably, this would all be accomplished with minimal disruption to the biller's payment receiving process. It would also be desirable if such a verification process could be conducted without the biller having to provide other parties with confidential consumer information and customer lists. It would also be preferable if a system could accelerate the posting of payments so that payments are posted on the day that the payment is received by the biller or the biller's agent (e.g., the concentrator). Finally, it would also be preferable if such a system could be easily integrated into the conventional system without having to modify the subsystems already in place in the conventional system.

### BRIEF SUMMARY

Embodiments of the present invention provide a computer program product for processing payments from a payor to a biller, the computer program product comprising a computer-readable storage medium having computer-readable program code portions stored therein. The computer-readable program code portions may include an executable portion configured for receiving payment data representing a payment from the payor to the biller and for verifying the accuracy the payment data before allowing the biller to accept the payment. The executable portion may be configured to verify the accuracy of the payment data by opening a batch file containing payment data, reading the contents of the batch file, and comparing the contents of the batch file to a database, a table, and/or an algorithm. In one embodiment, the database, table, and/or algorithm is maintained by the biller. For example, the database, table, and/or algorithm may provide a substantially real-time representation of at least a portion of the biller's account data.

In some embodiments, the executable portion may be further configured to identify payments associated with inaccurate payment data. In such embodiments, the executable portion may be configured to identify payments associated with inaccurate payment data by adding an identifier in the batch file that contains inaccurate payment data. The identifier may provide an indication that the payment data is not accurate. The executable portion may then be configured to return the batch file to the source of the batch file from which the computer program product received the batch file. In some embodiments, the source of the batch file from which the computer program product received the batch file may be an entity other than the payor.

Embodiments of the present invention also provide a method of receiving and processing payments from a payor to a biller. The method may involve: (i) receiving payment data related to a payment sent from a payor; (ii) verifying the accuracy of the payment data by comparing the payment data to a database maintained by the biller before allowing the biller to accept the payment; and (iii) identifying payments associated with inaccurate payment data. The method may further involve allowing the biller to accept payments that include accurate data. In some embodiments of the method, the database provides a substantially real-time representation of the biller's accounts.

In an exemplary embodiment of the method, verifying the accuracy of the payment data by comparing the payment data to a database maintained by the biller involves: (i) opening a batch file containing the payment data; (ii) reading the contents of the batch file; and (iii) comparing the contents of the batch file to the database. In some embodiments, verifying the accuracy of the payment data by comparing the payment data to a database maintained by the biller includes accessing a data server maintained by the biller, and comparing the payment data to a database maintained by the biller on the data sever. In other embodiments, verifying the accuracy of the payment data by comparing the payment data to a database maintained by the biller includes communicating the at least a portion of the payment data to the biller, and receiving an indication from the biller of the accuracy of the at least a portion of the payment data. In still other embodiments, the method may involve receiving account information from the biller to maintain the database.

In one embodiment, receiving payment data related to a payment sent from a payor comprises receiving payment data from a source. In such an embodiment, identifying payments that do not include accurate data comprises providing the source of the payment data with an indication that the received payment data is inaccurate. In some embodiments, at least a portion of the payment data comprises at least a portion of the payor's account number with the biller.

Embodiments of the present invention further provide a system for processing payments and verifying the accuracy of payment data related to a payment sent from a payor to a biller prior to allowing the biller to accept the payment. The system may include a processing element capable of receiving the payment data. The processing element may also be capable of accessing a database maintained by the biller, the database containing account information. The processing element may further be capable of comparing the payment data to account information from the database maintained by the biller to verify the accuracy of the payment data before allowing the biller to accept the payment.

The processing element may further be capable of identifying payments associated with inaccurate payment data by providing the source of the payment data with an indication that the received payment data is inaccurate. In some embodiments, the processing element is capable of receiving payment data from a source other than the payor. The database may provide a substantially real-time representation of the biller's accounts.

In one embodiment, the processing element is further capable of storing the database. In such an embodiment, the processing element may further be capable of receiving account information from the biller and using the account information received from the biller to update the database.

In another embodiment, the processing element is capable of accessing a data server maintained by the biller. The processing element may then be further capable of verifying the accuracy of the payment data by comparing the payment data to a database maintained on the biller's data server.

In still another embodiment, the processing element may be capable of communicating the payment data to the biller and receiving an indication from the biller of the accuracy of the at least a portion of the payment data.

In one embodiment, the processing element is capable of receiving and verifying payment data related to payments sent to the biller from many different payors. Similarly, in some embodiments, the processing element is capable of receiving and verifying payment data related to payments sent to many different billers. In an exemplary embodiment, the processing element is capable of receiving payment data from a concentrator and is further capable of returning an indication to the concentrator that the payment is not accurate if the processing element determines that payment data associated with the payment does not include accurate data.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a block diagram illustrating the typical parties to a conventional payment receiving and processing system;

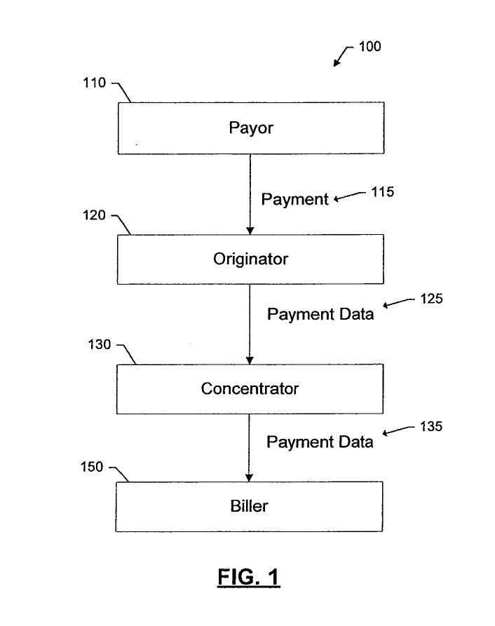

FIG. 2 is a flow chart illustrating an exemplary payment receiving and processing system that may be operated by the parties shown in FIG. 1;

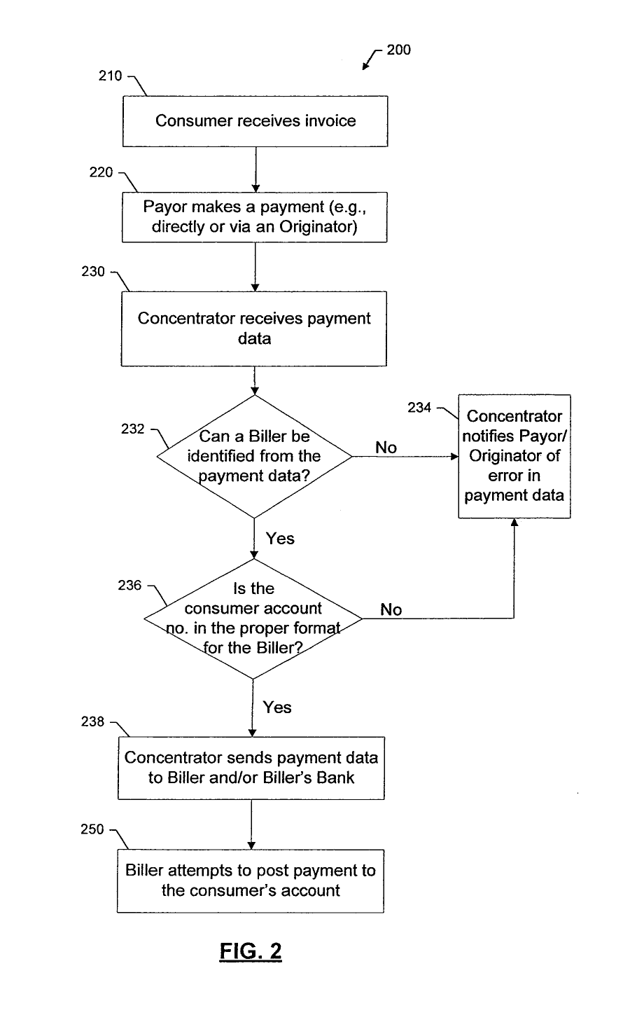

FIG. 3 is a block diagram illustrating the parties to a payment receiving and processing system according to one embodiment of the present invention;

FIG. 4 is a flow chart illustrating a payment receiving and processing system according to one embodiment of the present invention;

FIG. 5 is a flow chart illustrating one method by which the verification system may verify a consumer's account information, according to one embodiment of the present invention;

FIG. 6 is a flow chart illustrating another method by which the verification system may verify a consumer's account information, according to one embodiment of the present invention;

FIG. 7 is a flow chart illustrating yet another method by which the verification system may verify a consumer's account information, according to one embodiment of the present invention;

FIG. 8 is a flow chart illustrating one embodiment of a payment process that may be carried out by the verifier, according to one embodiment of the present invention; and

FIG. 9 is a flow chart illustrating one embodiment of a payment reversal process that may be carried out by the verifier, according to one embodiment of the present invention.

### DETAILED DESCRIPTION OF EMBODIMENTS OF THE INVENTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

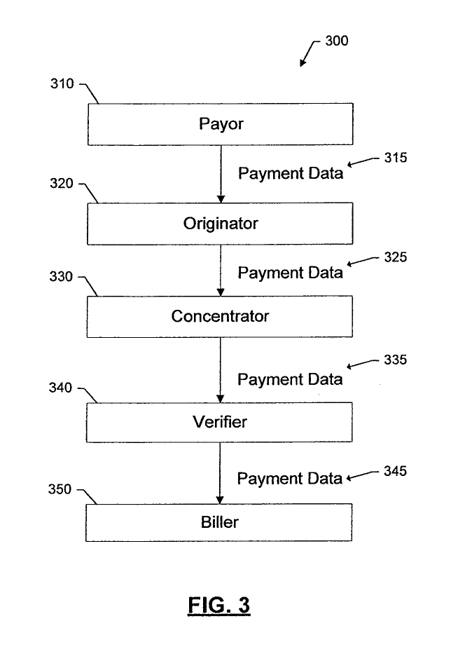

Referring to FIG. 3, there is illustrated some of the parties that may be involved in an exemplary payment receiving and processing system 300, according to one embodiment of the present invention. For example, the parties that will often be involved in the payment receiving and processing system generally include at least one payor 310, at least one originator 320, at least one concentrator 330, a verifier 340, and a biller 350.

The biller 350 may be any party that originates bills or statements for goods or services rendered to a consumer. For example, the biller 350 may be a business, the government, or an intermediary billing and collection service. Examples of the types of businesses that often act as billers include alarm service provides, electric service providers, water service providers, telephone service providers, Internet service providers, cable television service providers, natural gas service providers, and other utility providers.

The payor 310 is typically the consumer of the biller's goods or services. The payor 310, however, may be another party submitting payment for the consumer. In a typical system, the biller 350 sends bills to many consumers requiring the consumer or other payor to remit payment to the biller for the bill. The biller may send the invoice directly to the consumer either electronically or via the mail system. The biller may also send an invoice to a consumer indirectly using one or more third parties in the billing process.

As described above, an “originator” 320 is considered herein to be any entity that takes payment from a payor 310 with the intent of forwarding the payment to the biller 350. For example, as described above, many payors would like to pay their bill in cash. In some systems, these payors may be able to tender payment to an originator 320. The originator 320 is typically a party other than the biller that is willing to accept a payor's tender of payment on a bill and forward the payment on to the biller. For example, a grocery store may be considered an originator 320 if the grocery store accepts payments on behalf of a utility company. As also described above, another example of an originator 320 may be a third-party bill-pay system operated by a party other than the biller. For example, such a bill-pay system may attempt to consolidate all of a payor's bills from various billers in one place so that the payor can view and/or pay all of the payor's bills at one time by going to a single place on the Internet and using a single password. Although, FIG. 3 only illustrates a single originator 320, a payment receiving and processing system according to embodiments of the present invention may comprise many different originators accepting payments from many different payors for many different billers.

Referring to FIG. 3, there is also illustrated a concentrator 330. As described above, due to the overhead often associated with receiving and processing payments, many billers 350 require payors 310 (or their originators 320) to submit their payments to a central receiving location, often referred to as a “concentrator” 330, instead of having payors 310 submit their payments directly to the biller 350. The concentrator 330 then transmits the payments or select payment data to the appropriate biller 350. Although a biller usually has only one concentrator in charge of funneling payments to it, the biller may have more than one concentrator. The concentrators, on the other hand, often receive payments for many different billers.

According to one embodiment of the present invention, the exemplary payment receiving and processing system illustrated in FIG. 3 further includes a verifier 340. The verifier 340 is a party other than the biller that is capable of receiving payment data from the concentrator 340 before such payment data is sent to the biller 350. In one embodiment, the verifier is capable of receiving payment data not just from the concentrator 340, but also directly from one or more originators 320 and/or from one or more payors 310. Generally, the function of the verifier 340 is to verify at least a portion of the payment data directed towards a biller 350. Preferably, in one embodiment, the verifier 340 receives the payment data and verifies that data before any money is accepted by the biller 350. The verifier 340 preferably is capable of checking at least a portion of the payment data that it receives against the biller's records in real time. In one embodiment of the present invention, the verifier 340 accelerates the process by which credits are posted to the consumer's account in the biller's database. According to one embodiment, the biller contracts with a single verifier, while the verifier may verify payment information for many different billers.

Therefore, as illustrated in FIG. 3, an exemplary payment receiving and processing system 300 according to one embodiment of the invention may involve a payor 310 submitting a payment 315 to an originator 320. The originator 320 may then submit payment data 325 relating to the payor's payment 315 to the biller's concentrator 330. The concentrator 330 then sorts through the payment data 325 that it receives (either directly from payors 310 or their originators 320) in order to determine which payments go to the biller 350. The concentrator 330 will periodically (e.g., several times a day) send a batch file to the verifier 340 containing payment data 335 related to the payment data 325 received from one or more payors 310 or originators 320. The verifier 340 receives the payment data 335 and verifies at least a portion of that data before the biller accepts a payment related to the payment data 335 or attempts to post the associated credit to a consumer's account. It should be noted that payment data 325, payment data 335, and payment data 345 may not comprise exactly the same information. For example, as described above, each party may choose to send the next party only a portion of the remittance data that it received and may transmit payment data in a variety of formats.

Note that, for simplicity purposes, FIG. 3, the remaining figures, and the accompanying description do not include an exhaustive description of all of the parties, systems, and processes that may be present in a payment receiving and processing system according to various embodiments of the present invention. For example, naturally the payor's bank is often involved in a typical payment processing system, as is the biller's bank. As such, where FIG. 3 illustrates that the verifier 340 sends payment data 345 to the biller 350, the payment may go from the verifier directly to the biller or, alternatively, may go to the biller 350 through the biller's bank (not shown). Other conventional parties or systems that are not shown in the figures but may be involved in the system include a clearing house system or other system for transferring money between the various banks and financial institutions that may be involved in the system.

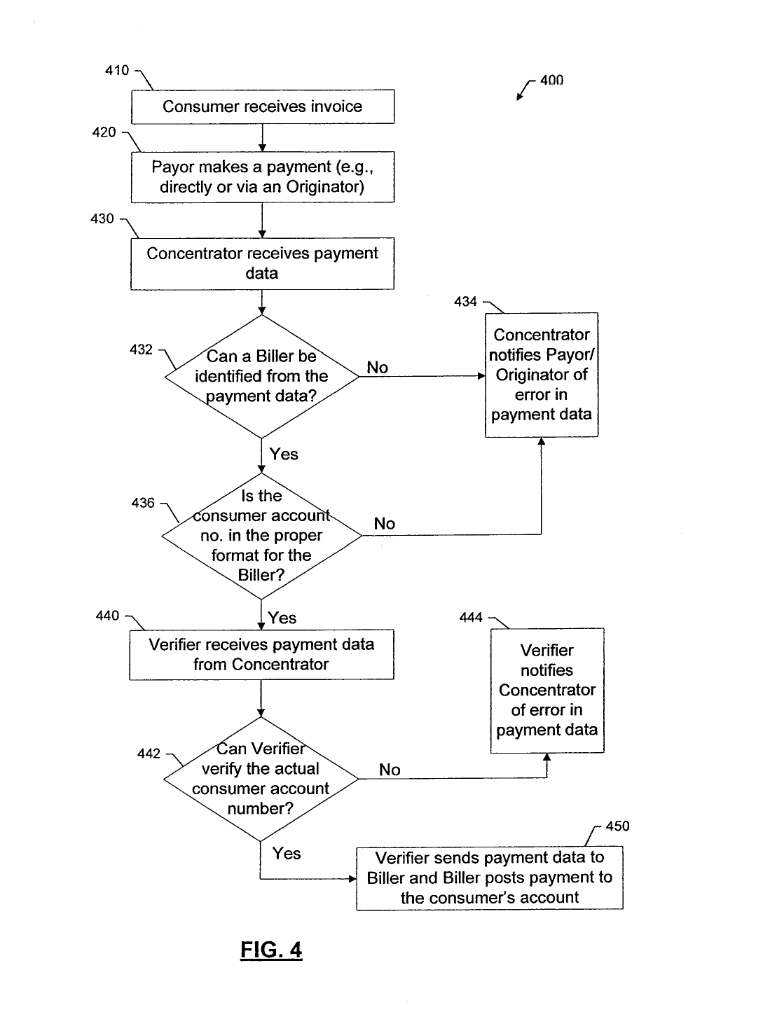

Referring to FIG. 4, there is illustrated a payment receiving and processing system and method 400, according to one embodiment of the present invention. In one embodiment of the present invention, the process illustrated in FIG. 4 and the remaining figures may be preformed by the parties illustrated in FIG. 3. For simplicity, such an embodiment will be described herein, although the parties in other embodiments of the present invention may differ. For example, in one embodiment, the verifier and the concentrator may be combined into one party.

As represented by block 410 of FIG. 4, the consumer may receive an invoice from the biller. The invoice may include remittance information that the biller uses to associate the bill, and any payment made toward the bill, with the consumer's account. Such remittance information may include a consumer account number representing the consumer's account with the buyer and a minimum amount due on the consumer's account. The remittance information may also include other information such as a payment due date, an account balance, the consumer's name and address, the biller's name and address, and/or any other data that may be useful to link the payment to the biller and/or to the consumer's account with the biller.

When a consumer receives a bill from a biller 350, the consumer or other payor 310 submits a payment to the biller by transmitting a form of payment along with some remittance information. As described above and as illustrated in FIG. 4, the biller has contracted with a concentrator 330 to receive, and at least partially process, payments directed to the biller 350. Therefore, as represented by block 420, the payor submits a payment to the concentrator. In one embodiment, the payor submits its payment to the concentrator via one or more originators 320. For example, along with a check or other form of payment, the payor may send a remittance stub or other remittance information that the consumer received from the biller with the biller's invoice. For instance, along with a form of payment, the payor may submit a consumer account number, a consumer's name and address, the biller's name and address, the payor's name and address, and/or any other remittance-related data. In some cases, a payor may make a payment to a biller without receiving an invoice. In these cases, the payment may not include much remittance information at all and may only include, for example, a payor's name and address and/or a consumer account number written on a check.

If the payor transmits a payment through an originator, the originator may forward payment data on to the concentrator in a variety of ways. Some originators may simply forward the payor's payment directly to the concentrator exactly as it was presented to the originator. For example, a payor may present to the originator all of the remittance information on the invoice along with a form of payment. Some originators may forward all of this remittance information to the concentrator. Other originators, however, may only choose to send the information that they consider to be necessary for the biller to have in order to associate the payment with a particular consumer's account. For example, the originator may choose to only send the concentrator the consumer's account number with the biller. Likewise, with regard to the payor's actual form of payment, some originators may forward the payor's form of payment to the concentrator exactly as the originator receives it, while other originators may keep the payor's form of payment and submit to the concentrator its own form of payment in lieu of one or more payors' payments. For example, the originator may only send the concentrator a single file at the end of each day including a list of account numbers and an amount tendered for each account number. The originator may even use a “check-and-list” presentment method, presenting such a file with one large check covering all of the amounts paid to the listed consumer accounts.

As a result of the variety of presentment systems that a payor may choose to use, the concentrator may receive many different forms of payment data for a particular biller, as represented by block 430 in FIG. 4. The concentrator may receive payments directly from many payors and may also receive payment data and/or check-and-list payment data from many originators. Furthermore, since the concentrators usually work for many billers, the concentrators not only receive payment data from many sources, but the concentrators also receive payment data directed to many different billers. As such, the concentrators must sort through all of the payment data that it receives and attempt to locate which payments go to which biller.

In this regard, as represented by block 432, the concentrator must determine whether a biller can be identified from the payment data that the concentrator receives. The concentrator may decide this by searching for a known biller identifier, such as a known biller name, a known biller bank account number, or a predetermined biller identification number. If the concentrator cannot identify a known biller from the received payment data, the concentrator may then return the payment to the payor or originator from which it came and/or notify the payor or originator that there was an error in the payment data, as represented by block 434.

In some systems, the concentrator takes an additional step, represented by block 436, of determining whether the consumer account numbers that it receives are in the proper format for the identified biller. So that the concentrator may make this determination, the biller may provide the concentrator with one or more standard formats that all of the biller's consumer account numbers should be in. For example, all of the consumer account numbers for a certain biller may begin with a particular collection of characters or all of the account numbers may consist of a certain quantity of numbers or letters. In some systems, a biller provides the concentrator with an algorithm that the concentrator can use to determine if a consumer account number belongs to or is a valid consumer account number for that biller. If the concentrator determines that a consumer account number that it receives with some payment data does not match the account number format of the biller identified by that payment data, the concentrator may then return the payment to the payor or originator from which it came and/or notify the payor or originator that there was an error in the payment data, as represented by block 434.

If the concentrator determines that the received payment data does identify a known biller and has the proper consumer account number format, the concentrator can present payment data to the biller. In a typical conventional system, the concentrator combines all of the payments that it receives for a particular biller and periodically (e.g., once per day) submits to the biller batch files of payment data for the preceding day. However, in the embodiment of the present invention illustrated by FIG. 4, payment data from the concentrator is sent to the verifier 340, as represented by block 440 in FIG. 4. According to one embodiment of the present invention, the concentrator sends batch files of payment data to the verifier several times per day. In another embodiment, the verifier receives payment data as soon as the concentrator receives and/or processes payment data intended for the biller. In another embodiment, the verifier receives payment data from the concentrator whenever the verifier requests such data from the concentrator and the concentrator has such data.

Once the verifier 340 receives payment data intended for a particular biller, the verifier verifies part or all of the payment data by comparing the payment data with information obtained from the biller's records. In one embodiment of the present invention, the verifier compares the payment data to information obtained from the biller's records in real-time. In the embodiments of the present invention illustrated by FIGS. 4-7, the verifier determines whether the consumer account numbers that it receives from the concentrator are valid account numbers that correspond to actual consumer accounts maintained by the biller. See Block 442.

Just as the consumer account numbers can be validated by the verifier, other information may also be validated by the verifier. For example, if the verifier receives other payment data in addition to the amount paid and the consumer account number, the verifier may compare this other information to the records of the biller in real-time. In this regard, the verifier may be configured to verify such information as the consumer's name and address. The system may even be configured to compare the amount paid to the amount due on the consumer's account or to amounts typically paid for the consumer's account in the past. In one embodiment of the present invention, the verifier is configured to first query whether the received consumer account number represents an actual consumer account with the biller. Then, if the verifier cannot verify the consumer account number, the verifier is configured to attempt to compare other payment data (such as names and addresses) with the biller's records, if such other data has been received by the verifier.

As illustrated in FIG. 4, if the verifier can determine that the received consumer account number corresponds with an actual consumer account that the biller has records for (or if the verifier can otherwise verify the received payment data based on comparing the payment data with other information provided by the biller), the verifier sends payment data to the biller so that the biller may immediately post the appropriate credit to the appropriate consumer account, as represented by block 450. The payment data that the verifier sends to the biller typically will include the amount paid and the verified consumer account number, although the payment data may include other payment information if other information has been provided to the verifier and if the biller desires to receive such information. Advantageously, the present invention enables the biller to post the transactions in the same day, which reduces unnecessary expenses associated with disconnecting and reconnecting accounts that have been paid, as well as avoiding inquiries from government regulatory entities regarding the same.

Alternatively, if the verifier cannot verify that the received consumer account number corresponds to an actual consumer account with the biller (or if the verifier cannot otherwise verify the received payment data based on comparing the payment data with other information provided by the biller), the verifier sends the payment and/or payment data back to the concentrator from which it came, as represented by block 444. In addition to or as an alternative to sending the payment and/or payment data back to the concentrator, the verifier may provide some indication to the concentrator as to why the payment is being returned and/or what part of the data could not be verified, as also represented by block 444.

It should be appreciated that embodiments of the present invention may therefore be useful to catch “bad” payments, such as payments with errors in the payment information, before the actual payment funds flow into the biller's bank account. In this way, the “bad” payments can be immediately returned to their source, thereby reducing the costs to the biller associated with posting bad payments and/or trying to determine the errors in the payment. Instead, in the exemplary system above, the bad payment will be immediately sent back to the concentrator. If the concentrator determines that the error was not made by it, the concentrator will likely send it back to the originator. In this way, the bad payment will go back through the system to the party that made the error or to the party that is in the best position to know who made the payment and/or what consumer account the payment is supposed to be directed to. In other words, the biller will not be required to research these “bad” payments.

In one embodiment of the system illustrated by FIG. 4, the process represented by block 436, where the concentrator determines whether the received consumer account number is in a format consistent with the typical consumer account number for a particular biller, may not occur. For example, where the verifier is verifying consumer account numbers, the verifier is conducting a more focused verification process than merely checking the format of the consumer account numbers. Therefore, it may be considered unnecessary for the concentrator to perform the function represented by block 436. Indeed, another advantage of the present invention is that the biller does not have to supply confidential data or otherwise open multiple access points to its computer system. Moreover, the present invention increases the reliability of the information the biller receives and, thus, reduces the biller's overhead expenses associated with processing bad payments.

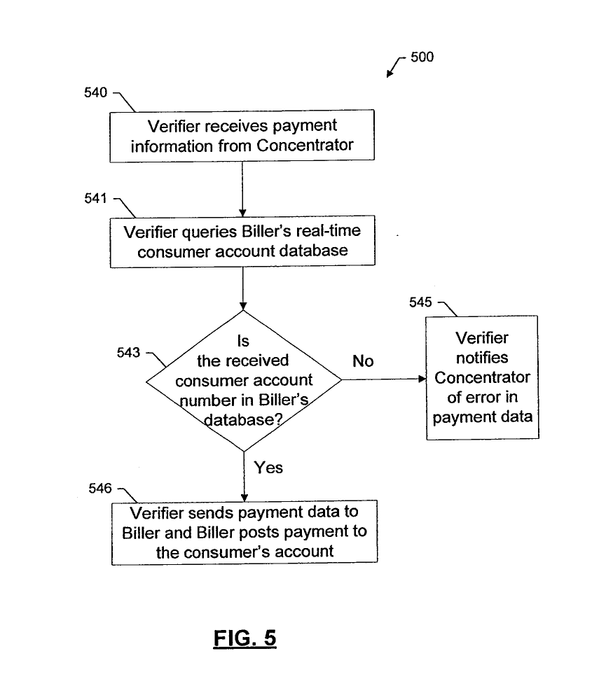

The verification process used by the verifier in order to compare, analyze and process received payment data against the biller's records may vary with various embodiments of the present invention. Referring to FIGS. 5-7, there are illustrated schematic block drawings of three embodiments of the systems of the present invention by which the verifier can validate received consumer account numbers (or other payment data).

According to one embodiment of the present invention, as illustrated in FIG. 5, the verifier receives payment information from the concentrator (or from an originator or a payor). See Block 540. In the depicted embodiment, the verifier queries the biller's consumer account database in real time, as represented by block 541. The process of querying the biller's database in real-time may involve the verifier directly accessing the biller's computer system and using one or more secure passwords to access the consumer account database on the biller's computer system. The verifier may conduct such a query via a wired or a wireless network, a LAN, a WAN, or the Internet. Preferably, verifier uses a secure connection between it and the biller's database so as to maintain security of the biller's and the consumer's confidential information. In one embodiment, the verifier maintains the connection with the biller's database while it conducts at least two or more queries. In other embodiments, the verifier must link to the biller's database each time the verifier is going to make a query.

Once the verifier has access to the biller's database, the verifier determines whether the consumer account number that the verifier received as part of the payment data from the concentrator corresponds to a valid consumer account maintained by the biller for which the biller is willing to accept a payment to. See Block 543. The verifier may make such a determination by comparing the received consumer account number with all of the consumer account numbers found in the biller's database. Additionally, according to one embodiment of the invention, the verifier may also look for comments in the biller's database related to the received consumer account number. In this regard, the biller may be able to use the verifier for the additional function of refusing a payment or otherwise flagging a payment directed to a particular consumer account number of interest.

As represented by block 545, if the verifier cannot verify the received consumer account number, the verifier notifies the concentrator of the error and/or returns the payment to the concentrator from which it came, as described above. In one embodiment, the verifier may report the errors to the biller, for example, for use in quality control.

However, if the verifier can verify that the received account number is an actual consumer account number maintained by the biller, and/or if the biller has not indicated some other reason for not wanting to accept payment, the verifier sends payment data to the biller (or otherwise allows the transaction from the concentrator to the biller to proceed) so that the biller may post the appropriate payment to the verified consumer account, as represented by block 546. Preferably, the verifier sends this data immediately after the payment data is verified. The payment data may include the verified consumer account number and the amount paid to that consumer account number, as well as the form of payment. The payment data may, however, also include other payment information if other information has been provided to the verifier and if the biller desires to receive such information.

The embodiment of the present invention illustrated by FIG. 5 may be particularly advantageous to the biller and the consumer since the biller may not have to do anything other than provide the verifier with access to its database. In this way, consumer information is more likely to remain confidential since the biller can more easily regulate who can access its own database compared to a system where the biller actually sends out copies of its database. Furthermore, the biller does not have much overhead associated with such a system. In addition, in some embodiments of the present invention, the credit for the payment is posted to the consumer's account that same day, rather than the typical next-day posting.

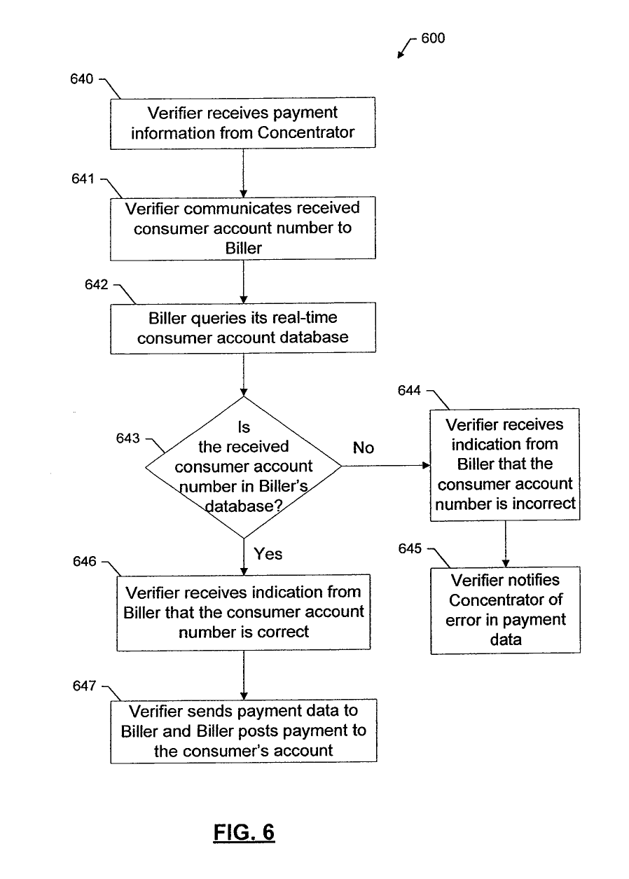

According to another embodiment of the present invention, as illustrated in FIG. 6, the verifier receives payment information from the concentrator (or from an originator or payor). See Block 640. The verifier then communicates to the biller a consumer account number received in said payment information, as represented by block 641. The communication between the verifier and the biller may be conducted using any system of communication. Preferably, however, the verifier communicates with the biller electronically via a wired or a wireless network, such as a LAN, a WAN, or the Internet, such that the communication is nearly instantaneous.

Once the biller receives the consumer account number from the verifier, the biller queries its own database, as represented by block 642, and determines whether the consumer account number that the verifier received as part of the payment data from the concentrator corresponds to a valid consumer account maintained by the biller. See Block 643. The biller may make such a determination by comparing the received consumer account number with all of the consumer account numbers found in its database. Additionally, according to one embodiment of the invention, the biller may also look for comments in its database related to the received consumer account number. In this regard, the biller may be able to use the verifier to refuse a payment or otherwise flag a payment directed to a particular consumer account number.

As represented by block 644, if the biller cannot verify the received consumer account number, the verifier receives an indication from the biller that the consumer account number could not be verified. The verifier then notifies the concentrator of the error and/or returns the payment to the concentrator from which it came, as described above, and as represented by block 645.

However, if the biller can verify that the received account number is an actual account number maintained in its systems, and/or if the biller desires to accept payment, the verifier receives an indication from the biller that the consumer account number has been verified, as represented by block 646. The verifier then sends the payment and/or rest of the payment data to the biller (or otherwise allows the transaction from the concentrator to the biller to proceed) so that the biller may post the appropriate payment to the verified consumer account, as represented by block 647. Preferably, the verifier sends this data immediately after the payment data is verified. The payment data may include the verified consumer account number and the amount paid to that consumer account, as well as the form of payment. The payment data may, however, also include other payment information if other information has been provided to the verifier and if the biller desires to receive such information.

It should be appreciated that this embodiment of the present invention may be even more secure than even the embodiment described in relation to FIG. 5 above. In particular, the biller does not have to provide general access to its database and does not have to provide copies of its database to third parties. Instead, the verifier's system interacts with the biller's system in order to provide individual queries to the biller's system based on the payment data presently being considered by the verifier. Therefore, embodiments of the present invention may allow the biller to receive payments by having a single interface with a third party, as opposed to multiple interfaces. A single interface will likely require less overhead and is more secure than multiple interfaces.

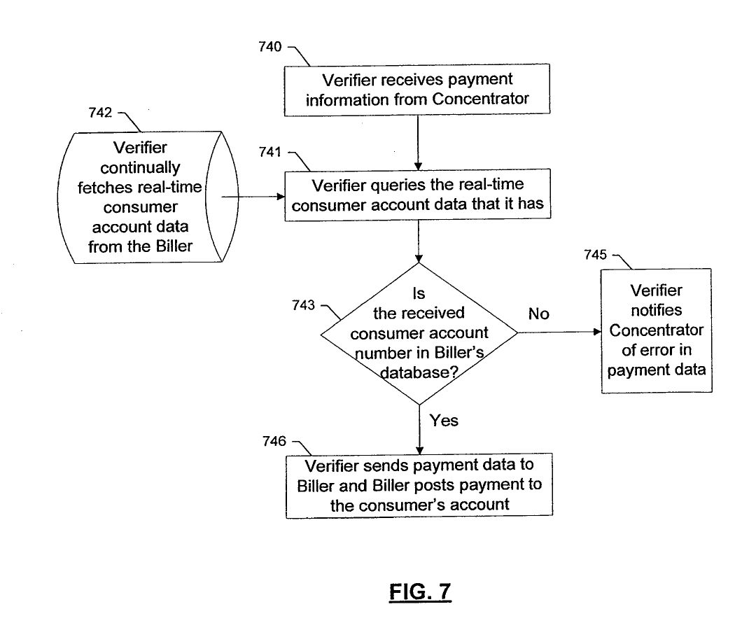

According to yet another embodiment of the present invention, as illustrated in FIG. 7, the verifier receives payment information from the concentrator (or from an originator or payor). See Block 740. In the depicted embodiment, the verifier queries its own consumer account number database that it has on hand for the particular biller, as represented by block 741. The verifier maintains such a database in real time, or in near real time, by continually fetching, or otherwise receiving, consumer account numbers from the biller's database, as represented by block 742. The process of receiving data from the biller's database may involve the verifier directly accessing the biller's computer system and using one or more secure passwords to access the consumer account database on the biller's computer system. The verifier may access the biller's database via a wired or a wireless network, a LAN, a WAN, or the Internet. Preferably, the verifier uses a secure connection between it and the biller's database so as to maintain security of the biller's and the consumer's confidential information. Alternatively, the process of receiving data from the biller's database may involve a one-way communication portal between the biller and the verifier where the biller continually transmits real-time consumer account records.

By comparing the received consumer account number to the consumer account number data that it continually receives from the biller's database, the verifier determines whether the consumer account number that the verifier received as part of the payment data from the concentrator corresponds to a valid consumer account maintained by the biller. See Block 743. The verifier may make such a determination by comparing the received consumer account number with all of the consumer account numbers received from the biller's database.

As represented by block 745, if the verifier cannot verify the received consumer account number, the verifier notifies the concentrator of the error and/or returns the payment to the concentrator from which it came, as described above. In one embodiment, the verifier may report the errors to the biller, for example, for use in quality control.

However, if the verifier can verify that the received account number is an actual account number maintained by the biller, and/or if the biller has not indicated some other reason for not wanting to accept payment, the verifier sends payment data to the biller (or otherwise allows the transaction from the concentrator to the biller to proceed) so that the biller may post the appropriate payment to the verified consumer account, as represented by block 746. Preferably, the verifier sends this data immediately after the payment data is verified. The payment data may include the verified consumer account number and the amount paid to that consumer account number, as well as the form of payment. The payment data may, however, also include other payment information if other information has been provided to the verifier and if the biller desires to receive such information.

According to one embodiment of the present invention, the verifier conducts one or more of the verification processes described above using a computer program product. In one embodiment, the computer program product requires that the biller install a portion of the computer program product into the biller's computer system. However, in a preferred embodiment, the computer program product is configured with the flexibility so that it may communicate with many different billers, regardless of the different computer systems that may be used by the different billers.

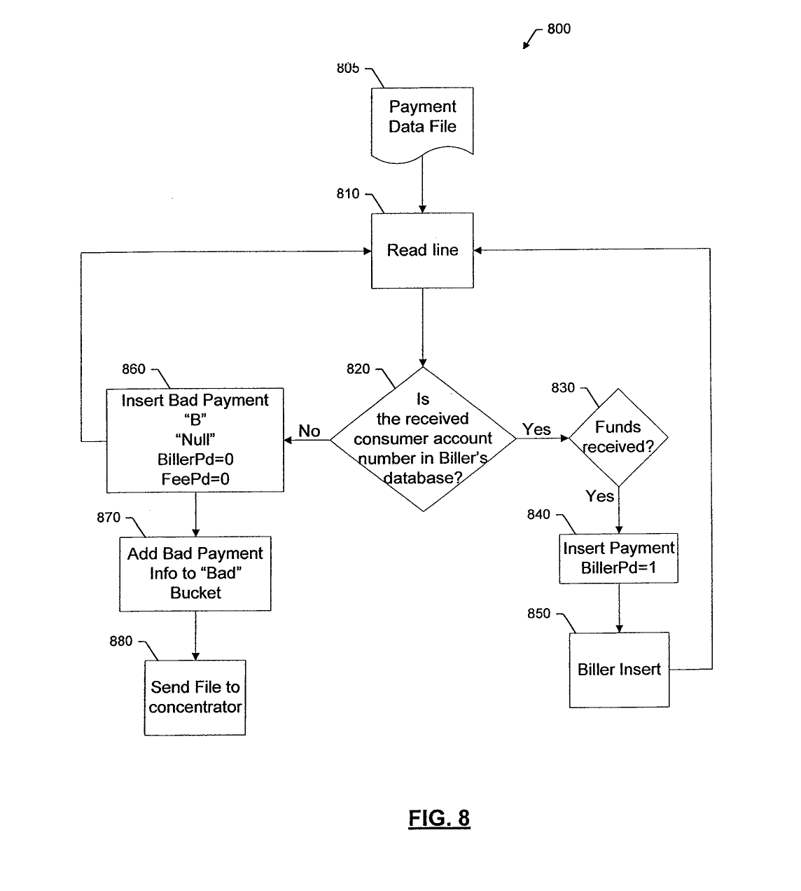

Referring to FIG. 8, an exemplary embodiment of a payment process 800 for verifying payment data received from a concentrator is illustrated. In one embodiment, the illustrated process is conducted by the verifier. The verifier receives a file 805 from a concentrator (or an originator or even a payor) containing payment data. The payment data may comprise header records in the file. As represented by block 810, the verifier reads a line in the file, such as a line of header records related to a particular payment. The verifier then checks the consumer account number that it reads in the line from the file and compares it with the biller's records, preferably in real time, to determine whether the account is “good” or “bad.” If the consumer account number is considered good (e.g., the consumer account number was found in the biller's records), the verifier may then run a check to see if the funds have been received for that payment, as represented by block 830. If the funds have been received, the payment is considered good and the Billers part of the file is set to equal a value of one (on/yes), as represented by block 840. In this way, the credit for the payment is posted to the consumer's account in the biller's database.

On the other hand, if the consumer account is considered bad (e.g., the consumer account number was not found in the biller's records), the Billers part of the file is set to equal a value of zero (off/no), as represented by block 860. Other ways of indicating a bad payment in the file may be to add a “B” to the file or a null value. The bad payment records are stored in a “bad” bucket or file, as represented by block 870. The payment records in the bad bucket are periodically returned to the source of the records, such as the concentrator, as represented by block 880.

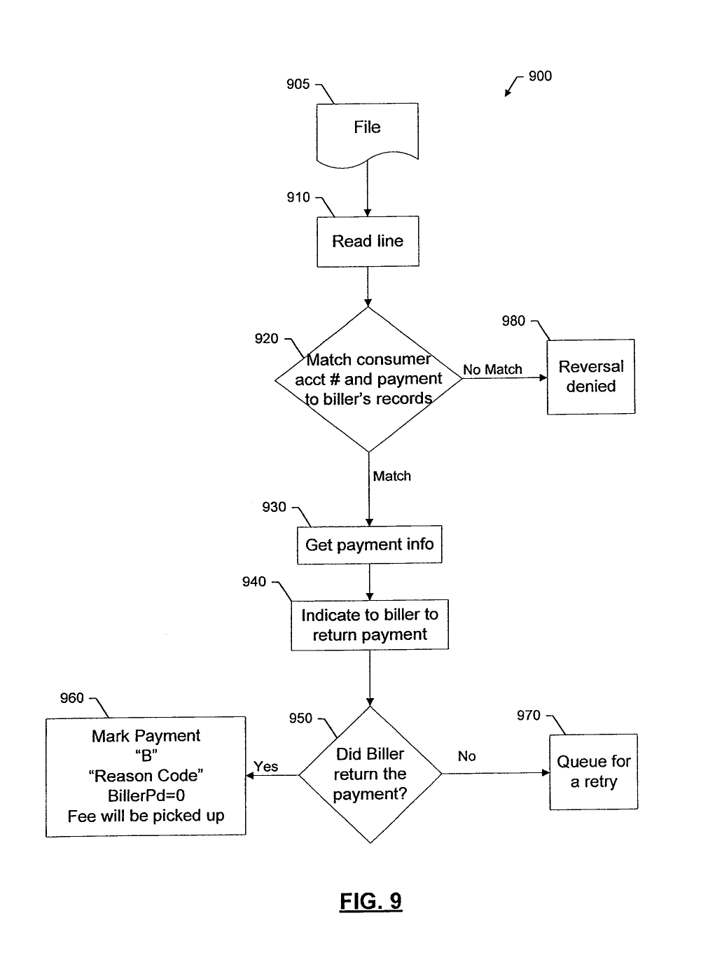

Referring to FIG. 9, an exemplary embodiment of a payment reversal process 900 for reversing a payment is illustrated. In one embodiment, the illustrated process is conducted by the verifier. This process may be used to reverse a payment that has posted to a consumer's account. The verifier receives a file 905 from a concentrator (or an originator or even a payor) containing data indicating that a payment has been or needs to be reversed. This reversal data may comprise header records in the file. As represented by block 910, the verifier reads a line in the file, such as a line of header records related to a particular payment reversal. The verifier then checks the consumer account number and the reversal data that it reads in the line from the file and compares it with the biller's records for consumer accounts and payment data, preferably in real time, to determine whether the account numbers match and the reversal data matches the payment data. See Block 920. If the reversal records do not match either a valid account number or a payment on that account number, the reversal is denied, as represented by block 980. If the reversal records match the biller's payment records, the verifier may then get the payment information from the biller's records, as represented by block 930. The verifier may then indicate to the biller to return the payment as indicated by the found payment information, as represented by block 940. The verifier then checks to see if the biller has returned the payment, as represented by block 950. If the payment has been returned, the payment marked “B” with perhaps a reason code, and Billers is set back to zero (no/off), as represented by block 960. If the biller has not returned the payment, the record is queued for a retry, as represented by block 970.

According to one aspect of the present invention, all or a portion of the system of the present invention generally operates under control of a computer program product. The computer program product for performing the methods of embodiments of the present invention includes a computer-readable storage medium, such as a nonvolatile storage medium, and computer-readable program code portions, such as a series of computer instructions, embodied in the computer-readable storage medium.

In this regard, FIGS. 3-9 are flowcharts of methods, systems, and computer program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A computer program product embodied on a non-transitory computer readable medium for processing payments from a payor to a biller, the computer program product comprising a computer-readable storage medium having computer-readable program code portions stored therein, the computer-readable program code portions comprising:
an executable portion configured for receiving payment data representing a payment from the payor to the biller and for verifying the accuracy of at least a portion of the payment data before allowing the biller to accept the payment;
wherein the executable portion is configured to verify the accuracy of the at least a portion of the payment data by opening a batch file containing payment data, reading the contents of the batch file, and comparing the contents of the batch file to a database, a table, and/or an algorithm maintained by the biller, wherein the database, table and/or algorithm comprises data for a plurality of payors.

2. The computer program product of claim 1, wherein the database, table, and/or algorithm provides a substantially real-time representation of at least a portion of the biller's account data.

3. The computer program product of claim 1, wherein the executable portion is further configured to identify payments associated with inaccurate payment data.

4. The computer program product of claim 3, wherein the executable portion is configured to identify payments associated with inaccurate payment data by adding an identifier in the batch file that contains inaccurate payment data, the identifier indicating that the payment data is not accurate, and wherein the executable portion is further configured to return the batch file to the source of the batch file from which the computer program product received the batch file.

5. The computer program product of claim 4, wherein the source of the batch file from which the computer program product received the batch file is an entity other than the payor.

6. A method of receiving and processing payments from a payor to a biller, comprising:
receiving payment data related to a payment sent from a payor;
portion of the payment data to a database maintained by the biller before allowing the biller to accept the payment, and wherein the database comprises data for a plurality of payors; and
identifying payments associated with inaccurate payment data.

7. The method of claim 6, further comprising:
allowing the biller to accept payments that include accurate data.

8. The method of claim 6, wherein the database provides a substantially real-time representation of the biller's accounts.

9. The method of claim 6, wherein verifying the accuracy of at least a portion of the payment data by comparing the at least a portion of the payment data to a database maintained by the biller comprises:
opening a batch file containing the payment data;
reading the contents of the batch file; and
comparing the contents of the batch file to the database.

10. The method of claim 6, wherein verifying the accuracy of at least a portion of the payment data by comparing the at least a portion of the payment data to a database maintained by the biller comprises:
accessing a data server maintained by the biller; and
comparing the at least a portion of the payment data to a database maintained by the biller on the data sever.

11. The method of claim 6, further comprising: receiving account information from the biller to maintain the database.

12. The method of claim 6, wherein verifying the accuracy of at least a portion of the payment data by comparing the at least a portion of the payment data to a database maintained by the biller comprises:
communicating the at least a portion of the payment data to the biller; and
receiving an indication from the biller of the accuracy of the at least a portion of the payment data.

13. The method of claim 6, wherein receiving payment data related to a payment sent from a payor comprises receiving payment data from a source, and wherein identifying payments that do not include accurate data comprises providing the source of the payment data with an indication that the received payment data is inaccurate.

14. The method of claim 6, where the at least a portion of the payment data comprises at least a portion of the payor's account number with the biller.

15. A system for processing payments and verifying the accuracy of payment data related to a payment sent from a payor to a biller prior to allowing the biller to accept the payment, the system comprising:
a processing element capable of receiving the payment data, said processing element also capable of accessing a database maintained by the biller and containing account information, and wherein said processing element is further capable of comparing the at least a portion of the payment data to account information from the database maintained by the biller to verify the accuracy of at least a portion of the payment data before authorizing the biller to accept the payment, and wherein the database comprises data for a plurality of payors.

16. The system of claim 15, wherein the processing element is further capable of identifying payments associated with inaccurate payment data, said processing element being further capable of providing a source of the payment data with an electronic notice that the received payment data is inaccurate.

17. The system of claim 15, wherein the processing element is capable of receiving payment data from a source other than the payor.

18. The system of claim 15, wherein the database maintained by the biller provides a substantially real-time representation of the biller's accounts.

19. The system of claim 15, wherein the processing element is further capable of electronically storing the account information from the database maintained by the biller, wherein the processing element is further capable of periodically receiving current account information from the biller, and wherein the processing element is further capable of using the account information received from the biller to update the stored account information.

20. The system of claim 15, wherein the processing element is capable of communicating the at least a portion of the payment data to the biller, and wherein the processing element is further capable of receiving an electronic notice from the biller indicating whether at least a portion of the payment data is accurate.

21. The system of claim 15, where the processing element is capable of receiving and verifying payment data related to payments sent to the biller from many different payors.

22. The system of claim 15, the processing element is capable of receiving and verifying payment data related to payments sent to many different billers.

23. The system of claim 15, wherein the processing element is capable of receiving payment data from a concentrator, and wherein the processing element is further capable of returning an electronic notice to the concentrator indicating that the payment is not accurate if the processing element determines that payment data associated with the payment does not include accurate data.
